(19) United States
(12) Patent Application Publication
(10) Pub. No.: US 2010/0091234 A1
(43) Pub. Date: Apr. 15, 2010

(54) Liquid Crystal Display Device

(76) Inventors: Yuji NAKAHATA, Kanagawa (JP); Tsuyoshi KAMADA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/578,176

(22) Filed: Oct. 13, 2009

(30) Foreign Application Priority Data
Oct. 14, 2008 (JP) P2008-265653

(51) Int. Cl. G02F 1/1339

(52) U.S. Cl. 349/155

(57) ABSTRACT

A liquid crystal display device is provided, suppressing formation of defect such as bubbles within a liquid crystal layer, to enhance yield. The liquid crystal display device includes: a first substrate and a second substrate facing each other; a liquid crystal layer provided between the first substrate and the second substrate to configure a plurality of pixels; a plurality of color filters formed on the first substrate, each of the plurality of color filters being divided into individual filter elements corresponding to the pixels, respectively; main spacers provided on one color kind of color filter of the plurality of color filters to control a gap between the first substrate and the second substrate; and sub spacers, which are lower than the main spacers in height, provided on the same color kind of color filter as the one color kind of color filter where the main spacers are provided thereon.

### BACKGROUND OF THE INVENTION

1. Field of the Invention

The present invention relates to a liquid crystal display device capable of displaying an image in color.

2. Description of Related Art

Recently, a liquid crystal display device employing a VA (Vertical Alignment) mode for example is used as a display monitor of a liquid crystal television, a notebook computer, a car navigation system and the like. The liquid crystal display device includes a liquid crystal layer provided between a drive substrate for driving pixels and a counter substrate on which color filters and the like are formed, and performs image display in accordance with an applied voltage.

The liquid crystal layer is formed by injecting a liquid crystal material into a space between the drive substrate and the counter substrate. A method of injecting liquid crystal is currently changed from a dip method to an ODF (One Drop Filling) method. In the dip method, the drive substrate and the counter substrate are attached together by using a seal member or the like, and liquid crystal is then injected into a space between the substrates. In the ODF method, the liquid crystal is dropped and then the drive substrate and the counter substrate are attached together in a vacuum. Particularly, the ODF method has been a mainstream for a large-sized liquid crystal panel.

In the ODF method, since the liquid crystal is dropped before the drive substrate and the counter substrate are attached together, a defect such as a bubble and an uneven gap due to gravity is formed within the liquid crystal layer when a dropping amount of the liquid crystal is not optimal with respect to capacity of the liquid crystal layer. Therefore, the ODF method includes photo-spacers that are disposed within the liquid crystal layer, for controlling a cell gap defined as a gap between the two substrates. However, when an arrangement density of the photo-spacers is increased, elasticity of the liquid crystal layer itself is reduced, which eventually induces formation of the bubble or the uneven gap due to the gravity. On the other hand, when the arrangement density is decreased, pressure resistance is reduced in the case that the liquid crystal layer is pressurized.

Thus, a technique referred to as a hybrid spacer has been proposed, as disclosed in Japanese Patent Application Publication No. 2001-201750, for example. In this technique, at least two types of spacers having different heights are arranged, and higher spacers (main spacers) normally support a liquid crystal layer, and lower spacers (sub spacers) support the liquid crystal layer when the liquid crystal layer is pressurized. The main spacers and the sub spacers are formed on color filters on a counter substrate side, respectively. Such a structure enables the liquid crystal layer to have both the elasticity and the pressure resistance.

### SUMMARY OF THE INVENTION

However, the following difficulty exists in the technique using the hybrid spacer, such as the technique disclosed in JP2001-201750A. That is, the color filters are configured, for example, by arranging R (Red), G (Green) and B (Blue) filter elements in a matrix pattern, and these color filter elements are patterned separately for each color, respectively. Therefore, thickness of the color filters varies for each color. When the main spacers and the sub spacers are provided on such color filters, a difference in height between the main spacers and the sub spacers is deviated from a designed value, and thus it is difficult to obtain desired elasticity of the liquid crystal layer. Therefore, there has been a difficulty that effects of the hybrid spacer are not sufficiently exhibited, so that the bubble or the uneven gap due to the gravity is formed within the liquid crystal layer, causing reduction in yield.

It is desirable to provide a liquid crystal display device capable of suppressing formation within a liquid crystal layer of a bubble or uneven gap due to the gravity to improve yield.

A liquid crystal display device according to an embodiment of the invention includes: a first substrate and a second substrate facing each other; a liquid crystal layer provided between the first substrate and the second substrate to configure a plurality of pixels; a plurality of color filters provided for a plurality of color kinds, respectively, and formed on the first substrate, each of the plurality of color filters being divided into individual filter elements corresponding to the pixels, respectively; main spacers provided on one color kind of color filter of the plurality of color filters to control a gap between the first substrate and the second substrate; and sub spacers, which are lower than the main spacers in height, provided on the same color kind of color filter as the one color kind of color filter where the main spacers are provided thereon.

In the liquid crystal display device according to the embodiment of the invention, the main spacers for controlling the cell gap, and the sub spacers, which are lower than the main spacers in height, are provided only on one color kind of the color filter of the plurality of color filters. Thereby, even if variation in thickness occurs for each of the colors in a formation step of the respective color filters, a difference in height between the main spacers and the sub spacers is easy to be accurately established in accordance with a design value.

According to the liquid crystal display device of the embodiment of the invention, the main spacers for controlling the cell gap, and the sub spacers which are lower than the main spacers in height, are provided only on one color kind of color filter of the plurality of color filters. Thus, even if the variation in thickness occurs for each of the colors in the formation step of the respective color filters, the difference in height between the main spacers and the sub spacers is accurately established. Therefore, it is possible to suppress formation within the liquid crystal layer of a bubble or uneven gap due to gravity, leading to improvement in yield.

### BRIEF DESCRIPTION OF THE DRAWINGS

FIGS. 1A and 1B illustrate a schematic configuration of a liquid crystal display device according to a first embodiment of the invention.

FIGS. 2A and 2B are section views for illustrating a manufacturing process of the liquid crystal display device illustrated in FIG. 1A.

FIGS. 3A and 3B are section views for illustrating steps subsequent to a step of FIG. 2B.

FIGS. 4A and 4B are section views for illustrating steps subsequent to the step of FIG. 3B.

FIG. 5 is a section view for illustrating another manufacturing process of the liquid crystal display device illustrated in FIG. 1A.

FIGS. 6A and 6B illustrate a schematic configuration of a liquid crystal display device according to an existing example.

FIGS. 7A and 7B illustrate a schematic configuration of a liquid crystal display device according to a second embodiment of the invention.

FIG. 8 is a section view illustrating a schematic configuration of a liquid crystal display device according to a modification of the embodiments of the invention.

FIG. 9 is a characteristic diagram illustrating a relationship of transmittance to a cell gap for each wavelength.

### DETAILED DESCRIPTION OF THE PREFERRED EMBODIMENTS

Hereinafter, preferred embodiments of the invention will be described in detail with reference to drawings.

### First Embodiment

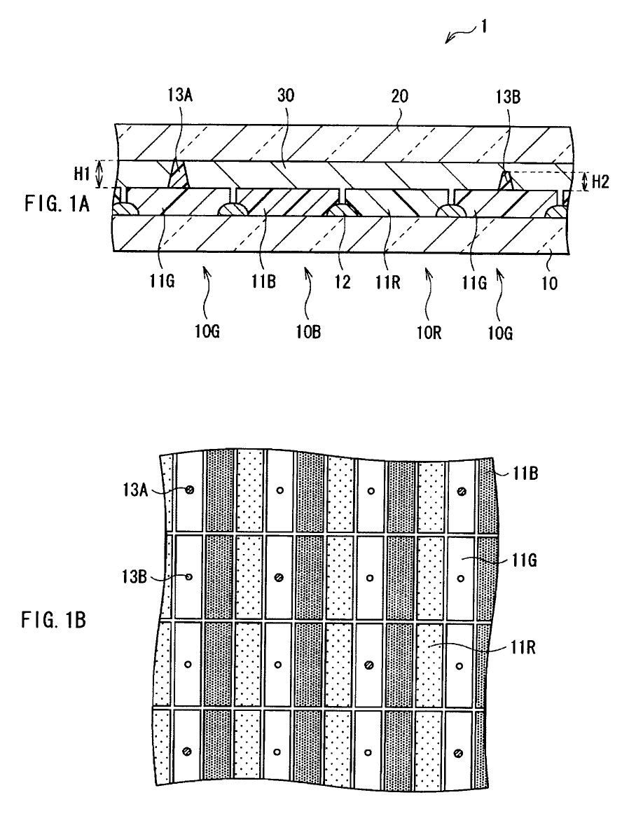

FIG. 1A is a section view illustrating a schematic configuration of a liquid crystal display device 1 according to a first embodiment of the invention. FIG. 1B is a schematic plan view illustrating an arrangement relationship between color filters, main spacers, and sub spacers. The liquid crystal display device 1 is, for example, an active-matrix display device performing image display, pixel by pixel, based on an image signal transmitted from a data driver (not illustrated) according to a drive signal supplied form a gate driver (not illustrated).

The liquid crystal display device 1 includes a liquid crystal layer 30 provided between a drive substrate 20 and a counter substrate 10. The liquid crystal layer 30 has a plurality of pixels arranged in a matrix pattern. For example, the liquid crystal layer 30 includes pixels 10R displaying red (R), pixels 10G displaying green (G), and pixels 10B displaying blue (B).

The drive substrate 20 includes TFT (Thin Film Transistors) provided on a glass substrate for example for driving the pixels 10R, 10G and 10B, and is formed with various wiring layers including gate lines and data lines connected to the TFT. Pixel electrodes (not illustrated) are provided on the drive substrate 20 for the respective pixels 10R, 10G and 10B, and an orientation film (not illustrated) is further formed to cover the pixel electrodes. The orientation film controls an orientation of the liquid crystal layer 30, and for example, a vertical-orientation organic film such as a polyimide film is used for the orientation film.

The counter substrate 10 includes, for example, a glass substrate, and includes a plurality of filters provided for a plurality of color kinds and divided into individual filter elements (red filter elements 11R, green filter elements 11G and blue filter elements 11B) disposed in correspondence to the pixels 10R, 10G and 10B, on a side of the liquid crystal layer 30. Moreover, a common electrode (not illustrated) common to pixels is formed on the counter substrate 10.

The red filter elements 11R, the green filter elements 11G, and the blue filter elements 11B selectively transmit a color component of red, green and blue, respectively, and absorb other color components, respectively. Each of the red filter elements 11R, the green filter elements 11G, and the blue filter elements 11B includes, for example, a photosensitive resin material such as photoresist dispersed with a pigment of each color. Thickness of each color filter is appropriately set according to desired color purity, which is 1.0 μm to 4.0 μm for example. Such red, green and blue filter elements 11R, 11G and 11B are formed in opening areas of a BM (black matrix) layer 12 respectively.

The BM layer 12 defines display areas of the pixels 10R, 10G and 10B, and prevents reflection of outside light at a boundary between the defined regions of the respective colors, and prevents light leakage between pixels, so as to increase contrast. The BM layer 12 includes a single-layer film or a stacked film of metal such as chromium (Cr), a metal oxide, or a metal nitride. Alternatively, the BM layer 12 may include acrylic resin mixed with carbon particles.

In the present embodiment, two kinds of spacers having different heights to each other (main spacers 13A and sub spacers 13B) are provided on the green filter among the red filter, the green filter, or the blue filter. The main spacers 13A normally keep a cell gap, defined as a gap between the two substrates 10 and 20, of the liquid crystal layer 30 to a certain interval. The main spacers 13A include, for example, a photosensitive photoresist. Height (thickness) H1 of the spacers 13A is appropriately set according to birefringence of the liquid crystal layer 30, which is 1.5 μm to 4.5 μm for example. The sub spacers 13B keep a certain cell gap of the liquid crystal layer 30 when the liquid crystal layer 30 is pressurized. The sub spacers 13B include, for example, the same material as that of the main spacers 13A, and height H2 thereof is low compared with the main spacers 13A, which is 1.0 μm to 4.4 μm for example. The height H2 of the sub spacers 13B is optimally set in consideration of a material of the spacers themselves, an arrangement density of the spacers, and the like.

A difference between the height H1 of the main spacers 13A and the height H2 of the sub spacers 13B is, for example, 0.1 μm to 0.5 μm, and often designed to be about 0.2 μm. When the difference between the height H1 and the height H2 is too small, the sub spacers 13B act as the main spacers 13A, and thus the liquid crystal layer 30 loses elasticity, causing formation of a bubble or uneven gap due to gravity. On the other hand, when the difference is too large, the sub spacers 13B may not work as a support when the liquid crystal layer 30 is pressurized, and therefore the spacers may not suppress uneven pressure. The difference between the height H1 and the height H2 described herein means a distance in a thickness direction between a top of the main spacer 13A and a top of the sub spacer 13B.

The main spacers 13A and the sub spacers 13B are provided only on one color kind of the color filter (i.e., the green filter, for example) among the red filter, the green filter, and the blue filter. In the present embodiment, the main spacer 13A and the sub spacer 13B are provided on the different green filter elements 11G. The main spacers 13A and the sub spacers 13B are preferably arranged such that density of the main spacers 13A is low and density of the sub spacers 13B is high, while such density varies depending on a material of the spacers itself.

The main spacers 13A and the sub spacers 13B are provided so as not to oppose TFT (not illustrated) on the drive substrate 20, respectively. The TFT is typically configured such that electrodes such as a gate, a source and a drain are connected to a channel-region-formation layer made of amorphous silicon (α-Si). Each of the main spacers 13A and the sub spacers 13B is provided in such a manner as to avoid particularly a region immediately above the amorphous silicon layer among the electrodes and the like. This prevents the main spacer 13A or the sub spacer 13B from contacting the drive substrate 20 and pressurizing the TFT. This in turn prevents occurrence of a threshold shift of the TFT due to the pressurizing of the TFT.

Alternatively, each of the main spacers 13A and the sub spacers 13B may be provided in a region opposed to the TFT or the wiring layer on the drive substrate 20. Such a configuration ensures spaces for placing the main spacers 13A and the sub spacers 13B without reducing an aperture ratio. Particularly, when each of the sub spacers 13B is arranged on the TFT, the sub spacer 13B is normally not contacted to the drive substrate 20. Thus, the occurrence of the threshold shift of the TFT is suppressed in the normal state.

The liquid crystal layer 30 includes, for example, a nematic liquid crystal of a VA (Vertical Alignment) mode, of a TN (Twisted Nematic) mode, or of an IPS (In-Plane Switching) mode.

A polarizing plate (not illustrated) is attached to the outside of each of the drive substrate 20 and the counter substrate 10, and a backlight (not illustrated) is provided on the outside of the drive substrate 20 for illuminating the liquid crystal display device 1 from the drive substrate 20 side. As the backlight, for example, an edge-light backlight using a light guide plate, a direct-light backlight, or the like is used. For example, the backlight includes CCFL (Cold Cathode Fluorescent Lamp), LED (Light Emitting Diode) or the like. Such a liquid crystal display device 1 is used as a display monitor for an electronic device such as a liquid crystal television, a notebook computer and so forth.

The liquid crystal display device 1 may be manufactured, for example, in the following way.

First, pixel electrodes, TFT, various wiring layers and the like are provided on a surface of a glass substrate to form the drive substrate 20.

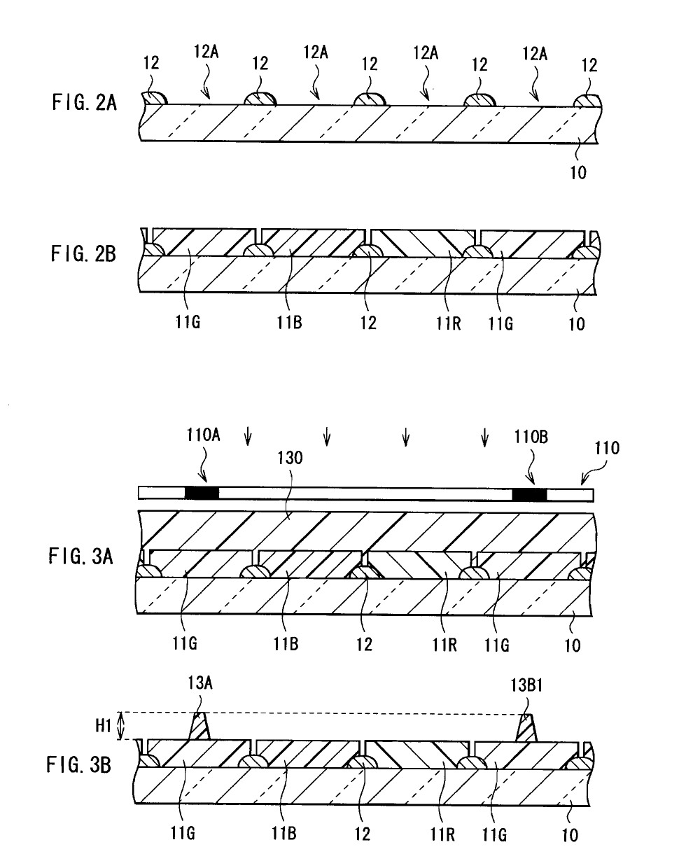

On the other hand, as illustrated in FIG. 2A, the BM layer 12 made of the above-described material is coated on a surface of the counter substrate 10, and then the BM layer 12 is patterned by, for example, a photolithography method to form the opening areas 12A. Next, as illustrated in FIG. 2B, the red filter, the green filter and the blue filter which are made of the above-described material are coated on the opening areas 12A of the BM layer 12, respectively, and then the filters are patterned in order through an exposure treatment and a development treatment with a photomask.

Next, the main spacers 13A and the sub spacers 13B are formed, for example, only on the green filter (green filter elements 11G) among the red, green and blue filters.

Specifically, a positive-type photosensitive resist 130 is first coated with a predetermined thickness H1 over the whole surfaces of the red, green and blue filters as illustrated in FIG. 3A for example. Thickness H1 of the formed photosensitive resist 130 corresponds to the height (thickness) H1 of the main spacers 13A. Then, regions other than predetermined formation regions of the main spacers 13A and of the sub spacers 13B in the resist 130 are selectively exposed at a given exposure condition. At that time, a photomask 110 having light-shielding portions 110A and 110B corresponding to the predetermined formation regions of the main spacers 13A and of the sub spacers 13B on the green filter is used. Thus, as illustrated in FIG. 3B, the main spacers 13A and sub spacers 13B1 each having the height H1 are formed on the green filter (green filter elements 11G), respectively.

Next, regions other than the main spacers 13A, namely the sub spacers 13B1 are selectively exposed as illustrated in FIG. 4A. At that time, a photomask 111 having light-shielding portions 111A in regions corresponding to the main spacers 13A is used for example. In this way, the sub spacers 13B having the height (thickness) H2 are formed on the green filter as illustrated in FIG. 4B.

In this way, the main spacer 13A and the sub spacer 13B each having different thickness from each other are formed by multi-step exposure with the photomasks 110 and 111. However, the method is not limitative, and the main spacers 13A and the sub spacers 13B may be formed in the following way.

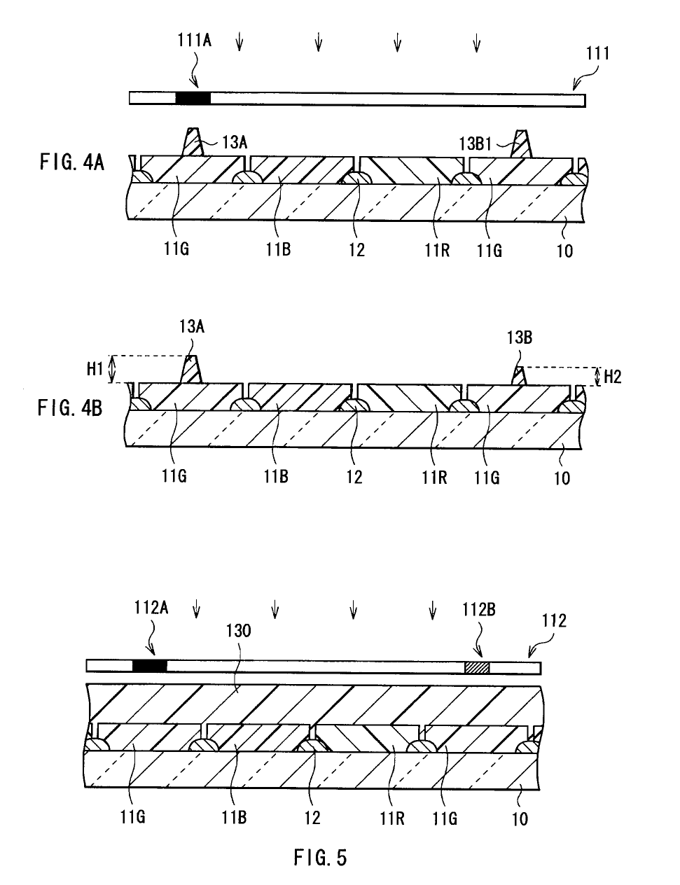

For example, as illustrated in FIG. 5, the photosensitive resist 130 is coated over the whole surfaces of the red, green and blue filters in a similar way as above. Then, the regions other than predetermined formation regions of the main spacers 13A and of the sub spacers 13B in the resist 130 are selectively exposed at a given exposure condition. At that time, a photomask 112 having light-shielding portions 112A corresponding to the predetermined formation regions of the main spacers 13A and semi-transmissive portions 112B corresponding to the predetermined formation regions of the sub spacers 13B is used for example. The semi-transmissive portion 112B includes a so-called half-tone mask or a gray-tone mask, and transmits light with a predetermined transmittance. Thus, the main spacers 13A having the height H1 and the sub spacers 13B having the height H2 are formed in one exposure.

Next, a UV-curing seal portion such as an epoxy adhesive is printed on the periphery of the counter substrate 10 having the main spacers 13A and the sub spacers 13B formed thereon, and then the liquid crystal layer 30 made of the above-described material is formed by dropping on the counter substrate 10 on a side where the respective color filters are formed. Then, the drive substrate 20 is attached to the counter substrate 10 with the liquid crystal layer 30 in between, and the attached substrates are subjected to UV irradiation so that the seal portion is cured. Thus, the liquid crystal layer 30 is formed between the drive substrate 20 and the counter substrate 10.

Finally, a not-illustrated polarizing plate is attached to an outer surface of each of the drive substrate 20 and the counter substrate 10 of the formed liquid crystal layer 30, so that the liquid crystal display device 1 illustrated in FIG. 1A is completed.

Next, operation and effects of the liquid crystal display device 1 having the above configuration is described.

In the liquid crystal display device 1, light irradiated from the not-illustrated backlight to the drive substrate 20 side enters the liquid crystal layer 30 through the drive substrate 20. The light having entered the liquid crystal layer 30 transmits therethrough while being modulated by each of the pixels when a voltage is applied between the pixel electrode on the drive substrate 20 and the common electrode on the counter substrate 10 based on image data. The light having transmitted through the liquid crystal layer 30 in this way passes through the red filter elements 11R, the green filter elements 11G and the blue filter elements 11B corresponding to the pixels 10R, 10G and 10B respectively, and thereby the light is extracted to the outside of the counter substrate 10 as display light of three primary colors, and display is thus performed.

The main spacers 13A having the height H1 and the sub spacers 13B having the height H2 lower than the height H1 are provided within the liquid crystal layer 30 respectively. Thus, the cell gap of the liquid crystal layer 30 is normally kept by the main spacers 13A, whereas the cell gap is kept by the sub spacers 13B when the liquid crystal layer 30 is pressurized. In this way, the main spacer 13A and the sub spacer 13B having different heights from each other are provided within the liquid crystal layer 30, thereby the elasticity and the pressure resistance of the liquid crystal layer 30 are kept in a well-balanced manner.

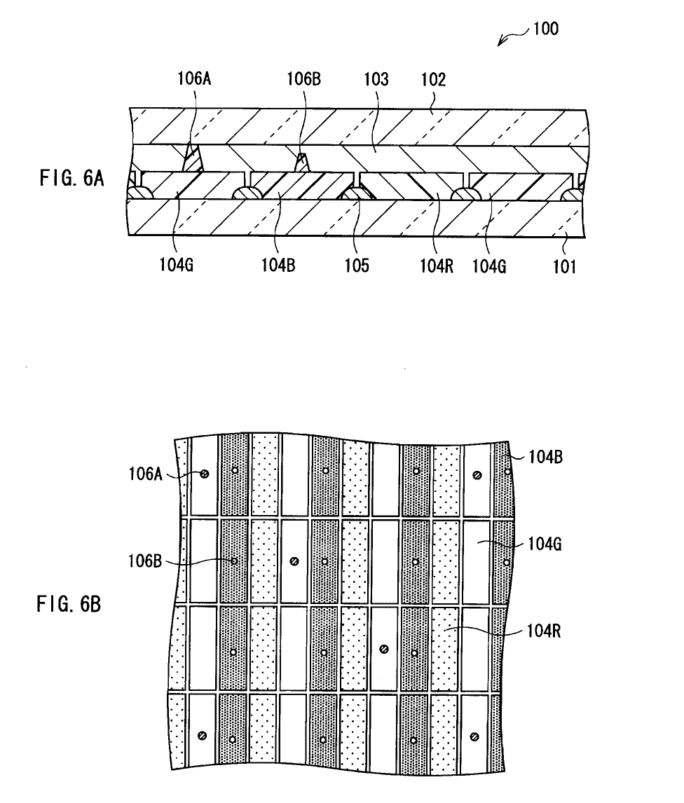

Here, an existing liquid crystal display device 100 is described with reference to FIGS. 6A and 6B. In the liquid crystal display device 100, a liquid crystal layer 103 is provided between a drive substrate 102 and a counter substrate 101, and a red filter, a green filter and a blue filter having red filter elements 104R, green filter elements 104G, and blue filter elements 104B, respectively, and a BM layer 105 are formed on the counter substrate 101. Main spacers 106A and sub spacers 106B, having a height lower than that of the main spacers 106A, are provided on surfaces of the red filter, the green filter and the blue filter. Specifically, for example, the main spacers 106A are provided on the green filter elements 104G, and the sub spacers 106B are provided on the blue filter elements 104B, respectively.

Accordingly, in the existing liquid crystal display device 100, the main spacers 106A and the sub spacers 106B are provided on the color filters having different color kinds from each other. Since formation of the red filter, the green filter and the blue filter is performed separately for each color, variation in thickness may occur among the red, green and blue filters. In such a case, when the main spacers 106A and the sub spacers 106B are provided on the filters having the different color kinds from each other, a difference in the height between the main spacers 106A and the sub spacers 106B is deviated from a design value, and variation in height also occurs in a substrate plane. This induces a defect within a liquid crystal layer such as a bubble and an uneven gap due to gravity.

On the other hand, in the present embodiment, the main spacers 13A and the sub spacers 13B are provided only on the color filter having the same color kind. For example, the main spacers 13A and the sub spacers 13B are provided only on the green filter (green filter elements 11G). Thus, even if the variation in thickness occurs for each of the colors in a formation step of the respective color filters, the difference between the height H1 and the height H2 is hardly deviated from the design value.

As hereinbefore, in the present embodiment, since the main spacers 13A and the sub spacers 13B are provided on only one color kind of the color filter among the red filter, the green filter and the blue filter, for example, only on the green filter, the difference between the height H1 of the main spacers 13A and the height H2 of the sub spacers 13B is easily established in accordance with the design value even when the thickness of the color filters varies in each of the colors. Therefore, the elasticity of the liquid crystal layer 30 is ensured in accordance with a design value, so that the defect such as the bubble and the uneven gap due to the gravity is suppressed, leading to improvement in yield.

### Second Embodiment

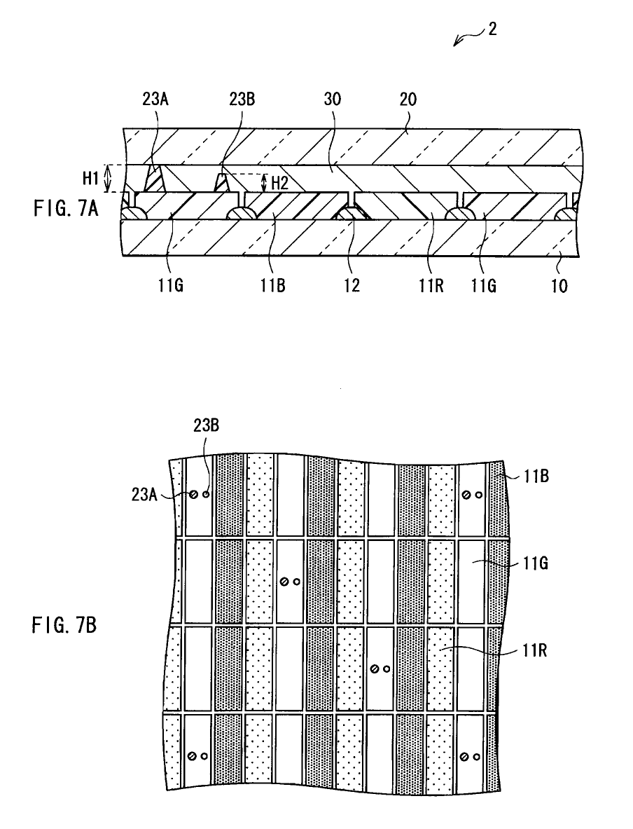

FIG. 7A is a section view illustrating a schematic configuration of a liquid crystal display device 2 according to a second embodiment of the invention. FIG. 7B is a schematic plan view illustrating an arrangement relationship between color filters, main spacers, and sub spacers. Hereinafter, elements similar to those in the first embodiment are attached with the same reference numerals or signs, and will not be described in detail.

The liquid crystal display device 2 is, for example, an active-matrix display device performing image display, pixel by pixel, based on an image signal transmitted from a data driver (not illustrated) according to a drive signal supplied form a gate driver (not illustrated). The liquid crystal display device 2 includes the liquid crystal layer 30 provided between the drive substrate 20 and the counter substrate 10, as in the liquid crystal display device 1 of the first embodiment. The liquid crystal layer 30 has the pixels 10R, the pixels 10G and the pixels 10B arranged in a matrix pattern.

In the present embodiment, main spacers 23A and sub spacers 23B are provided only on one color kind of color filter among the red filter, the green filter and the blue filter, as in the first embodiment. For example, the main spacers 23A and the sub spacers 23B are provided only on the green filter. However, in the present embodiment, both of the main spacer 23A and the sub spacer 23B are provided on a same pixel. That is, one main spacer 23A and one sub spacer 23B are provided only on the pixel 10G The main spacers 23A and the sub spacers 23B are formed to have the heights of H1 and H2 with the material equivalent to that of the main spacers 13A and the sub spacers 13B in the first embodiment, respectively. In addition, the main spacers 23A and the sub spacers 23B may be formed by using a photolithography method as in the main spacers 13A and the sub spacers 13B in the first embodiment.

Accordingly, in the present embodiment, the main spacer 23A and the sub spacer 23B are provided on the same pixel (the pixel 10G in the present embodiment). Thus, even if the thickness varies in each of the colors in the formation step of the respective color filters, a difference between the height H1 of the main spacers 23A and the height H2 of the sub spacers 23B is established in accordance with a design value. Moreover, although the thickness of the color filters may vary for each of the pixels even in the same color, the difference between the height H1 and the height H2 is kept constantly even in such a case. Thus, accuracy which is higher than that in the first embodiment is achieved. Therefore, the defect such as the bubble and the uneven gap due to the gravity is further effectively suppressed, leading to further improvement in yield.

Note that, in FIGS. 7A and 7B, the main spacers 23A and the sub spacers 23B are provided intermittently among the pixels 10G arranged in the matrix pattern. However, the main spacers 23A and the sub spacers 23B may be provided on all of the pixels 10G.

### [Modification]

Next, a modification of the embodiments of the invention is described. Hereinafter, elements similar to those in the first and the second embodiments are attached with the same reference numerals or signs, and will not be described in detail.

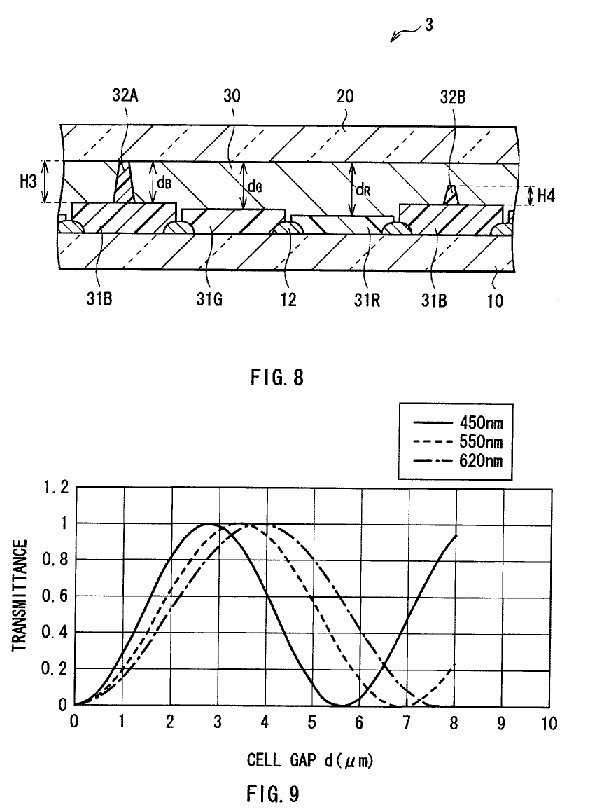

FIG. 8 is a section view illustrating a schematic configuration of a liquid crystal display device 3 according to the modification. The liquid crystal display device 3 includes the liquid crystal layer 30 provided between the drive substrate 20 and the counter substrate 10 as in the embodiments. Main spacers 32A and sub spacers 32B are provided only on one color kind of color filter among the red filter, the green filter and the blue filter. For example, the main spacers 32A and the sub spacers 32B are provided only on the blue filter (blue filter elements 31B). However, in the present modification, the red filter (red filter elements 31R), the green filter (green filter elements 31G), and the blue filter (blue filter elements 31B) are different in thickness from one another, and thus cell gaps d_{R}, d_{G} and d_{B} of the respective color pixels are different from one another, thereby establishing a multi-gap structure. Specifically, thickness is the largest in the blue filter element 31B, and is gradually reduced in order of the green filter element 31G and the red filter element 31R, so that the cell gaps of the respective color pixels have a relationship of d_{R}>d_{G}>d_{B}. In such a structure, the main spacers 32A and the sub spacers 32B are provided on the blue filter elements 31B having the largest thickness. However, the main spacer 32A and the sub spacer 32B are provided on the different blue filter elements 31B herein.

Accordingly, the embodiments of the invention are applicable to the multi-gap structure. Generally, when the liquid crystal layer 30 includes, for example, a VA-mode liquid crystal, and when an orientation of liquid crystal molecules is directed at an ideal angle of 45 degrees, transmission intensity (I) of light is given by the following formula (I). Wherein, I₀ is intensity of incident polarized-light, d is a cell gap, Δn is birefringence of a liquid crystal at an applied voltage (V), and λ is a wavelength of incident light in the air. Also, FIG. 9 illustrates a relationship of transmittance of a liquid crystal layer to the cell gap d in the case of Δn=0.08. As represented in the formula (I) and FIG. 9, the transmittance depends on the cell gap d, and varies for each wavelength. This indicates that when the cell gaps of R, G and B are the same, chromaticity is shifted due to gradation.

I=I₀*sin²(πΔnd/λ) Formula (I)

Therefore, variation in characteristics such as transmittance, a γ (gamma) curve and so forth are reduced by employing the multi-gap structure as in the present modification. This suppresses the shift in the chromaticity due to the gradation, so that color purity is improved. Moreover, the main spacers 32A and the sub spacers 32B are provided on one color kind of the color filter having the largest thickness (the blue filter elements 31B in the present modification). Thus, a height H3 and a height H4 are set low compared with a case where the main spacers 32A and the sub spacers 32B are provided on color filters of other color kinds. This facilitates reduction in the variation of spacer height in a substrate plane.

In the present modification, the main spacer 32A and the sub spacer 32B are provided on the different blue filter elements 31B, for example. However, the main spacer 32A and the sub spacer 32B may be provided on the same blue filter element 31B, as in the second embodiment. Moreover, in the present modification, although the thickness is the largest in the blue filter and is gradually reduced in order of the green filter and the red filter for example, the thickness of each of the color filters is not limited thereto. Since the transmittance varies depending on the cell gap as described above, each of the cell gaps d_{R}, d_{G} and d_{B} may be determined according to a desired cell gap, a thickness of each of the color filters or the like, such that the respective color pixels have the mutually-equivalent transmittance.

Hereinbefore, while the invention has been described with reference to the embodiments and the modification, the invention is not limited to the above embodiments and the modification, and may be variously modified. For example, although, in the above embodiments and the modification, the main spacers and the sub spacers are provided only on the green filter or on the blue filter, the main spacers and the sub spacers may be provided only on the red filter.

Moreover, in the above embodiments and the modification, either of the main spacer and the sub spacer is provided on the pixel 10G, or one main spacer and one sub spacer are provided on the pixel 10G, for example. However, the number of the main spacers and the number of the sub spacers provided on one pixel 10G are not limited thereto. That is, two or more main spacers and sub spacers may be provided on each pixel respectively, as long as the main spacers and the sub spacers are formed on the color filter elements having the same color. Alternatively, the main spacers and the sub spacers may be uniformly arranged on all pixels of the same color, or may be provided at intervals.

Furthermore, in the above embodiments and the modification, the red filter, the green filter, and the blue filter are provided on the counter substrate 10 side, for example. However, the respective color filters may be provided on the drive substrate 20 side to establish a so-called “color-filter-on-array (COA)” structure. In this structure, since thickness of each color filter often becomes larger than that in the case where the filter is provided on the counter substrate 10 side, the variation in thickness tends to occur for each color. Since the embodiments and the modification of the invention establish the difference in height between the main spacer and the sub spacer with accuracy even when the variation in thickness occurs among the respective color filters, it is particularly effective for the COA structure.

The present application contains subject matter related to that disclosed in Japanese Priority Patent Application JP 2008-265653 filed in the Japan Patent Office on Oct. 14, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. A liquid crystal display device, comprising:
a first substrate and a second substrate facing each other;
a liquid crystal layer provided between the first substrate and the second substrate to configure a plurality of pixels;
a plurality of color filters provided for a plurality of color kinds, respectively, and formed on the first substrate, each of the plurality of color filters being divided into individual filter elements corresponding to the pixels, respectively;
main spacers provided on one color kind of color filter of the plurality of color filters to control a gap between the first substrate and the second substrate; and
sub spacers, which are lower than the main spacers in height, provided on the same color kind of color filter as the one color kind of color filter where the main spacers are provided thereon.

2. The liquid crystal display device according to claim 1, wherein one or more main spacers and one or more sub spacers are provided in a same pixel of the plurality of pixels.

3. The liquid crystal display device according to claim 1, wherein the plurality of color filters are mutually different in thickness.

4. The liquid crystal display device according to claim 3, wherein the main spacers and the sub spacers are provided on one color kind of color filter having a largest thickness.

5. The liquid crystal display device according to claim 1, further comprising drive elements on the second substrate to drive the pixels, respectively, and
the main spacers and the sub spacers are provided in regions other than regions opposed to the drive elements.

6. The liquid crystal display device according to claim 1, further comprising drive elements and wiring layers on the second substrate to drive the pixels, respectively, and
the main spacers are provided in regions opposed to the wiring layers, and the sub spacers are provided in regions opposed to the drive elements.
